(19) United States
(12) Patent Application Publication
(10) Pub. No.: US 2010/0031474 A1
(43) Pub. Date: Feb. 11, 2010

(54) HINGE

(75) Inventor: JUNG-BIN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,418

(22) Filed: Dec. 9, 2008

(30) Foreign Application Priority Data
Aug. 7, 2008 (CN) 200820301780.3

(51) Int. Cl. E05D 5/10; A47B 96/06

(52) U.S. Cl. 16/386; 248/205.1

(57) ABSTRACT

A hinge includes a shaft, a bracket, a first interfering member, and a silencing member. The shaft includes a post, with a noncircular cross section. The bracket defines a pivot hole for the post of the shaft rotatably extending therethrough. The silencing member defines a noncircular through hole to be firmly mounted to the post of the shaft and a cutout. The first interfering member defines a non-circular through hole for the post of the shaft extending therethrough. The first interfering member includes a mounting portion engaged in the cutout of the silencing member to firmly mount the first interfering member to the silencing member.

### CROSS-REFERENCE TO RELATED APPLICATIONS

Relevant subject matter is disclosed in co-pending U.S. patent applications (application Ser. No. 12/205,931, Attorney Docket No. US20946, filed on Sep. 8, 2008 and entitled “HINGE AND INTERFERENCE APPARATUS FOR THE SAME,” application Ser. No. 12/202,331, Attorney Docket No. US20987, filed on Sep. 1, 2008 and entitled “HINGE AND INTERFERENCE APPARATUS FOR THE SAME;” and application Se. No. 12/205,932; Attorney Docket No. US20954, filed on Sep. 8, 2008 and entitled “HINGE AND INTERFERENCE ASSEMBLY THEREOF”), which are assigned to the same assignee as this patent application. The disclosure of the co-pending applications is incorporated herein by references.

### BACKGROUND

1. Technical Field

The disclosure relates to mechanical structures and, particularly, to a hinge.

2. Description of Related Art

A collapsible device, such as a notebook computer or a clamshell mobile phone, generally includes two parts pivotally connected via a hinge. The hinge generally includes a bracket mounted to one part of the collapsible device and a shaft with one end mounted to the other part of the collapsible device. The bracket includes a barrel rotatably receiving an opposite end of the shaft. For locating one part of the collapsible device relative to the other part of the collapsible device, the hinge includes a first interfering member un-rotatably mounted to the shaft, and a second interfering member rotatably fitting about the shaft and mounted to the bracket. The first interfering member is engagable with the second interfering member to position one part of the collapsible device relative to the other part of the collapsible device.

The first interfering member usually defines a noncircular through hole for the shaft extending therethrough. However, the through hole of the first interfering member is usually inexact and greater than the ideal size, resulting in the first interfering member loosely fitting about the shaft, which makes the shaft hit the sidewall bounding the through hole of the first interfering member while rotating the shaft, resulting in noises.

Therefore, the present disclosure provides a hinge to obviate the described limitations.

### BRIEF DESCRIPTION OF THE DRAWINGS

FIG. 1 is an exploded, isometric view of a first exemplary embodiment of a hinge.

FIG. 2 is an assembled, enlarged view of the hinge of FIG. 1.

FIG. 3 is an exploded, isometric view of a second exemplary embodiment of a hinge, the hinge includes a first interfering member and a silencing member.

FIG. 4 is an enlarged view of the first interfering member and the silencing member of FIG. 3.

### DETAILED DESCRIPTION

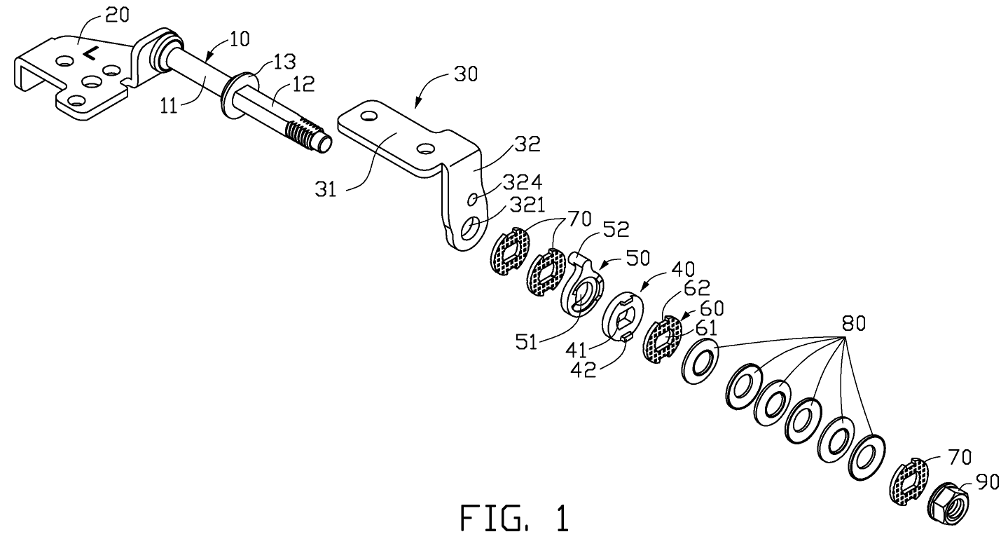

Referring to FIG. 1, a first exemplary embodiment of a hinge is adapted to be mounted to a collapsible device, such as a notebook or a clamshell mobile phone, that includes two parts rotatably connected to each other via the hinge. The hinge includes a shaft 10, a rack 20, a bracket 30, a first interfering member 40, a second interfering member 50 engagable with and rotatable relative to the first interfering member 40, a silencing member 60, a plurality of washers 70, a resilient assembly 80, and a fastener 90.

The shaft 10 includes a generally cylindrical-shaped pole 11, with a post 12 and an engaging portion (not shown) protruding from opposite ends of the pole 11. The post 12 has a noncircular, such as double-D shaped, cross section. A flange 13 is formed on the shaft 10, separating the pole 11 and the post 12. The distal end away from the pole 11 of the post 12 forms a threaded portion. The engaging portion is used to fix the shaft 10 to the rack 20.

The rack 20 includes a main body and a flange perpendicularly connected to a side of the main body. The engaging portion of the shaft 10 is fixed to the flange of the rack 20. A plurality of securing holes (not labeled) is defined in the main body, for mounting the rack 20 to one part of the collapsible device.

The bracket 30 includes a main body 31 and a flange 32 perpendicularly extending from an end of the main body 31. The main body 31 defines a plurality of securing holes therein, for mounting the bracket 30 to the other part of the collapsible device. The flange 32 defines a round pivot hole 321, for rotatably receiving the post 12 of the shaft 10. The flange 32 also defines a positioning hole 324 adjacent to the pivot hole 321.

The first interfering member 40 defines a double-D shaped through hole 41, corresponding to the post 12 of the shaft 10, to snugly fit about the post 12. Two opposite mounting portions 42 extend from a circumference of the first interfering member 40, away from the second interfering member 50. A side of the first interfering member 40 facing the second interfering member 50 forms a plurality of depressed portions or a plurality of protruded portions (not shown).

The second interfering member 50 defines a round through hole 51, for rotatably receiving the post 12. A side of the second interfering member 50 facing the first interfering member 40 forms a plurality of protruded portions or a plurality of depressed portions to engage with the plurality of depressed portions or the plurality of protruded portion of the first interfering member 40. An inserting portion 52 is formed on a circumference of the second interfering member 50, for being inserted into the positioning hole 324 to fix the second interfering member 50 to the bracket 30.

The silencing member 60 is a washer in the instant embodiment. The silencing member 60 defines a double-D shaped through hole 61 in its center, to snugly fit about the post 12. The silencing member 60 defines two opposite cutouts 62 in an edge thereof. Opposite sides of the silencing member 60 define a plurality of receiving holes (not labeled), for retaining lubricant.

Each washer 70 defines a double-D shaped through hole, to snugly fit about the post 12. Opposite sides of the washer 70 define a plurality of receiving holes, for retaining lubricant. In the instant embodiment, the washers 70 are structurally the same as the silencing member 60 and can be made with the same punching die, to save costs.

The resilient assembly 80 includes a plurality of resilient washers. These washers are stacked together, and rotationally retained around the post 12. In another embodiment, the resilient assembly 80 can be a spring or another resilient component. The fastener 90 is a hexagonal screw nut, and can be screwed to the threaded portion of the post 12.

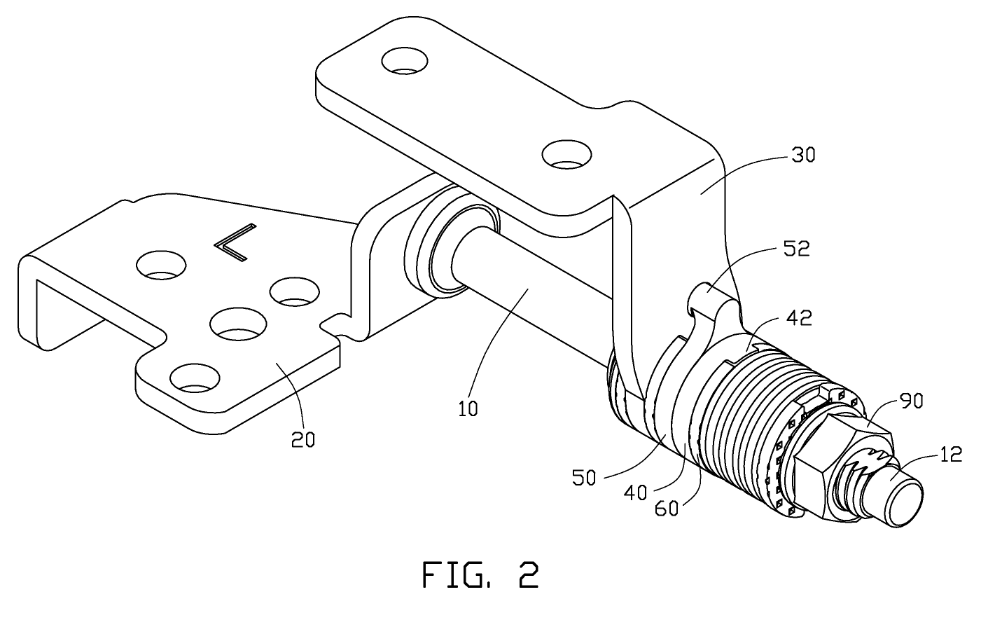

Referring to FIG. 2, in assembly, the post 12 of the shaft 10 is inserted through the pivot hole 321 of the bracket 30, with the flange 13 resisting the bracket 30, the through holes of two of the washers 70, the through hole 51 of the second interfering member 50, the through hole 41 of the first interfering member 40, the through hole 61 of the silencing member 60, the resilient assembly 80, and the through hole of another washer 70 in that order, to be screwed to the fastener 90. The inserting portion 52 of the second interfering member 50 is inserted into the positioning hole 324 of the bracket 30.

The mounting portions 42 engage in the cutouts 62 of the silencing member 60 to firmly mount the first interfering member 40 to the silencing member 60. The silencing member 60 is thus firmly mounted to the post 12 of the shaft 10. Thus, the first interfering member 40 is firmly mounted to the post 12 of the shaft 10, which prevents the post 12 hitting the inner surface of the through hole 41 of the first interfering member 40 noise caused by rotation of the post 12 of the shaft 10 in the pivot hole 321 of the bracket 30.

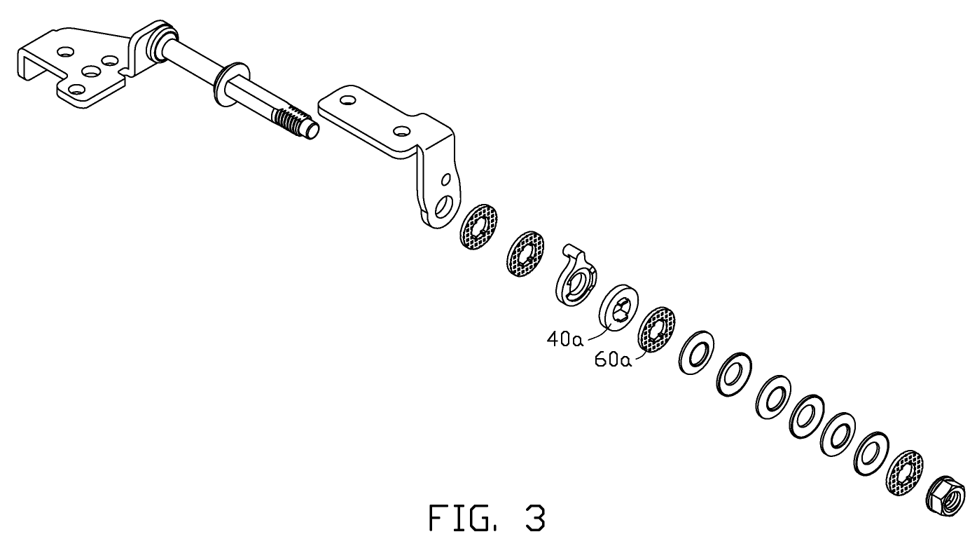

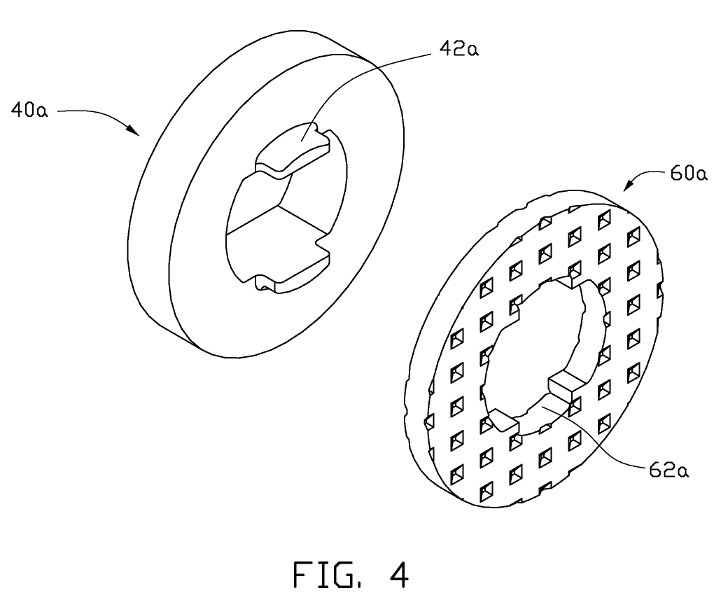

Referring to FIGS. 3 and 4, of a second exemplary embodiment, the silencing member 60a defines a double-D shaped through hole 61a in a center, to snugly fit about the post 12. The silencing member 60 also defines two opposite cutouts 62a in a sidewall bounding the through hole 61a. Correspondingly, two opposite mounting portions 42a protrude from the first interfering member 40a adjacent to the center through hole of the first interfering member 40a. The mounting portions 42a are engaged in the corresponding cutouts 62a to firmly mount the first interfering member 40a to the silencing member 60a.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a shaft comprising a post, with a noncircular cross section;
a bracket defining a pivot hole for the post of the shaft rotatably extending therethrough;
a silencing member defining a noncircular through hole to be firmly mounted to the post of the shaft, the silencing member defines a cutout; and
a first interfering member defining a non-circular through hole for the post of the shaft extending therethrough, the first interfering member comprising a mounting portion engaged in the cutout of the silencing member to firmly mount the first interfering member to the silencing member.

2. The hinge of claim 1, further comprising a second interfering member engaging with the first interfering member, wherein the second interfering member is mounted to the bracket, the post is rotatably inserted through the second interfering member.

3. The hinge of claim 2, further comprising a resilient assembly and a fastener, wherein the resilient assembly is rotatably retained around the post, the fastener is fixed to the post to limit the second interfering member, the first interfering member, and the resilient assembly on the post, and the resilient assembly is located between the first interfering member and the fastener.

4. The hinge of claim 3, wherein the resilient assembly comprises a plurality of resilient washers, these washers are stacked together and rotationally retained around the post.

5. The hinge of claim 3, further comprising a washer located between the resilient assembly and the fastener, wherein the washer defines a noncircular through hole to snugly fit about the post, and opposite sides of the washer define a plurality of receiving holes for retaining lubricant.

6. The hinge of claim 2, wherein the bracket defines a positioning hole, the second interfering member forms an inserting portion inserted into the positioning hole to fix the second interfering member to the bracket.

7. The hinge of claim 2, further comprising a washer located between the second interfering member and the bracket.

8. The hinge of claim 7, wherein the washer defines a noncircular through hole to snugly fit about the post.

9. The hinge of claim 1, wherein the mounting portion extends from the circumference of the first interfering member, the cutout is defined in an edge of the silencing member.

10. The hinge of claim 1, wherein the mounting portion extends from a sidewall bounding the through hole of the first interfering member, the cutout is defined in a sidewall bounding the through hole of the silencing member correspondingly.

11. A hinge, comprising:
a rack with a shaft fixed thereto, the shaft comprising a post whose cross section is noncircular;
a bracket defining a pivot hole for rotatably receiving the post therein;
a silencing member defining a noncircular through hole to be firmly mounted to the post of the shaft, the silencing member defines a cutout; and
a first interfering member defining a non-circular through hole to fit about the post, the first interfering member comprising a mounting portion engaged in the cutout of the silencing member to firmly mount the first interfering member to the silencing member; and
a second interfering member mounted to the bracket, the second interfering member capable of engaging with the first interfering member to optimize the rotation of the post of the shaft in the pivot hole of the bracket.

12. The hinge of claim 11, further comprising a resilient assembly and a fastener, wherein the resilient assembly is rotatably retained around the post, the fastener is fixed to the post to limit the first interfering member and the resilient assembly on the post, and the resilient assembly is located between the first interfering member and the fastener.

13. The hinge of claim 12, wherein the resilient assembly comprises a plurality of resilient frictional washers, these washers are stacked together and rotationally retained around the post.

14. The hinge of claim 11, wherein the bracket defines a positioning hole, the second interfering member forms an inserting portion inserted into the positioning hole to fix the second interfering member to the bracket.

15. The hinge of claim 11, wherein the second interfering member defines a round through hole, the post is rotatably inserted through the through hole of the second interfering member.

16. The hinge of claim 11, wherein the mounting portion extends from the circumference of the first interfering member, the cutout is defined in the edge of the silencing member correspondingly.

17. The hinge of claim 11, wherein the mounting portion extends from a sidewall bounding the through hole of the first interfering member, the cutout is defined in a sidewall bounding the through hole of the silencing member.

18. The hinge of claim 11, wherein a surface of first interfering member facing the second interfering member defines a plurality of protrusions; a surface of the second interfering member facing the first interfering member defines a plurality of depressions; the first and second interfering members the are capable of movably engaging each other via the protrusions and depressions.

19. The hinge of claim 11, wherein a surface of first interfering member facing the second interfering member defines a plurality of depressions; a surface of the second interfering member facing the first interfering member defines a plurality of protrusions; the first and second interfering members the are capable of movably engaging each other via the protrusions and depressions.
